(19) United States
(12) Patent Application Publication
(10) Pub. No.: US 2026/0225759 A1
(43) Pub. Date: Aug. 6, 2026

(54) CELLULOSE ESTER FOAMED ARTICLES

(71) Applicant: Eastman Chemical Company, Kingsport, TN (US)

(72) Inventors: Michael Eugene Donelson, Kingsport, TN (US); Goliath Beniah, York, PA (US); Stephanie Kay Clendennen, Kingsport, TN (US); Nicola Anne Herndon, Bristol, TN (US); Madeleine Kate Miller, Johnson City, TN (US); James Collins Maine, Church Hill, TN (US)

(73) Assignee: Eastman Chemical Company, Kingsport, TN (US)

(21) Appl. No.: 19/159,958

(22) PCT Filed: Feb. 27, 2024
(86) PCT No.: PCT/US2024/017387

§ 371 Date: Aug. 26, 2025

Related U.S. Application Data
(60) Provisional application No. 63/487,028, filed on Feb. 27, 2023.

(51) Int. Cl. B65D 1/34; B29C 48/00; B29C 48/07; B29K 1/00; B29K 105/00; B29K 105/04; B29L 31/00; B65D 25/34; B65D 75/00; B65D 81/26

(52) U.S. Cl. CPC B65D 1/34; B29C 48/0017; B29C 48/022; B29C 48/07; B65D 25/34; B65D 75/004; B65D 81/264; B29K 2001/12; B29K 2105/0038; B29K 2105/04; B29L 2031/712

(57) ABSTRACT

A tray comprising a cellulose ester. The tray is configured to experience a weight gain of less than 10% when submitted to a One-Hour Water Absorption Test, as described in the specification.

### BACKGROUND OF THE INVENTION

Many foam articles, such as food-packaging articles, are single-use items that are intended to be disposed of after use. One commercially important material used to make foam articles is polystyrene. However, polystyrene is neither compostable nor biodegradable. Moreover, some municipalities, states, and countries have enacted, or are considering enacting, bans on the use polystyrene-based foams. Thus, it would be desirable to find alternative materials for use in foam articles, as well as viable compositions, methods, and systems for producing such articles.

### SUMMARY OF THE INVENTION

In one embodiment or in combination with any other embodiment mentioned herein, there is provided a tray comprising cellulose ester. The tray is configured to experience a weight gain of less than 10% when submitted to a One-Hour Water Absorption Test, as described in the specification. In another embodiment or in combination with any other embodiment mentioned herein, there is provided a foamed article formed from a foamed material comprising cellulose ester and at least one plasticizer. The foamed material is industrial compostable according to ASTM D6400 thereby exhibiting disintegration of at least ninety percent within twelve weeks, as measured according to ISO 16929 (2013) under an elevated temperature of 58° C.±2° C. The foamed material is home compostable according to French Standard NF T 51-800 thereby exhibiting disintegration of at least ninety percent within twenty-six weeks, as measured according to ISO 16929 (2013) under an ambient temperature of 28° C.±2° C.

In another embodiment or in combination with any other embodiment mentioned herein, there is provided a thermoformed foamed article comprising a cellulose ester and a plurality of cells formed therein. At least 50% of the plurality of cells have a cross-sectional aspect ratio from 1:2 to 2:1.

In another embodiment or in combination with any other embodiment mentioned here, there is provided a method of forming a foamed article. The method comprises a step of producing a foamed sheet from a composition comprising cellulose ester. An additional step includes thermoforming the foamed sheet, thereby forming the foamed article having an article density. The article density is no more than 0.095 g/cm³.

In another embodiment or in combination with any other embodiment mentioned herein, there is provided a method of forming a foamed article. The method comprises a step of producing a foamed sheet from a composition comprising cellulose ester and having a sheet density. An additional step includes thermoforming the foamed sheet, thereby forming the foamed article having an article density. The article density is least 20% less than the sheet density.

In another embodiment or in combination with any other embodiment mentioned herein, there is provided a method of forming a foamed article. The method comprises producing a foamed sheet from a composition comprising cellulose ester and a physical blowing agent. An additional step includes thermoforming the foamed sheet, thereby forming the foamed article having less than 1 wt. % of the physical blowing agent twenty-four hours after the thermoforming.

### BRIEF DESCRIPTION OF THE DRAWINGS

FIG. 1 is a schematic diagram illustrating a biodegradable article forming process according to embodiments of the present invention;

FIG. 2 is a schematic diagram illustrating another biodegradable article forming process according to embodiments of the present invention;

FIG. 3 is a schematic diagram illustrating an extrusion section that may be used in the article forming processes of FIGS. 1 and/or 2, according to embodiments of the present invention;

FIG. 4 is a schematic diagram illustrating another extrusion section that may be used in the article forming process of FIGS. 1 and 2, according to embodiments of the present invention;

FIG. 5 is a schematic diagram illustrating a sheet forming section that may be used in the article forming processes of FIGS. 1 and/or 2, according to embodiments of the present invention;

FIG. 6 is a top plan view of a foamed article, in the form of a food tray, according to embodiments of the present invention

FIG. 7A is a scanning electron microscope image of a cross-section of a cellulose ester-based foam sheet before thermoforming; and

FIG. 7B is a scanning electron microscope image of a cross-section of a cellulose ester-based foam sheet after thermoforming.

### DETAILED DESCRIPTION

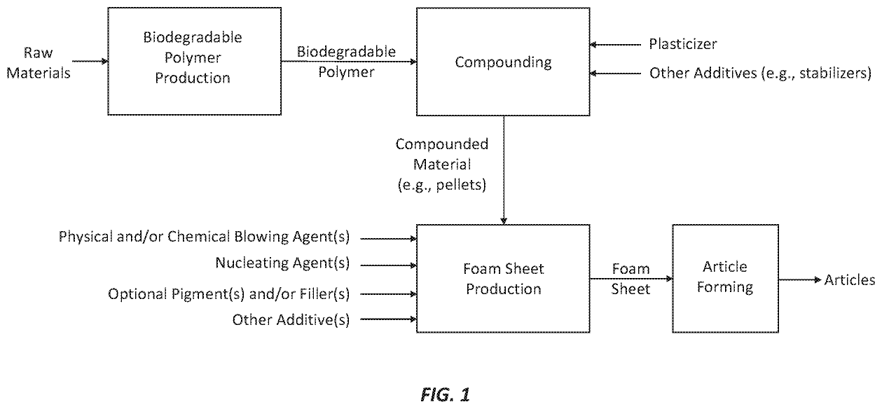

Embodiments are generally directed to methods, systems, and compositions for forming biodegradable particulate materials (e.g., pellets), foam sheets, and articles. Exemplary processes including the methods, systems, and compositions are depicted in FIGS. 1-5 and are described in greater detail below.

### Methods and Systems

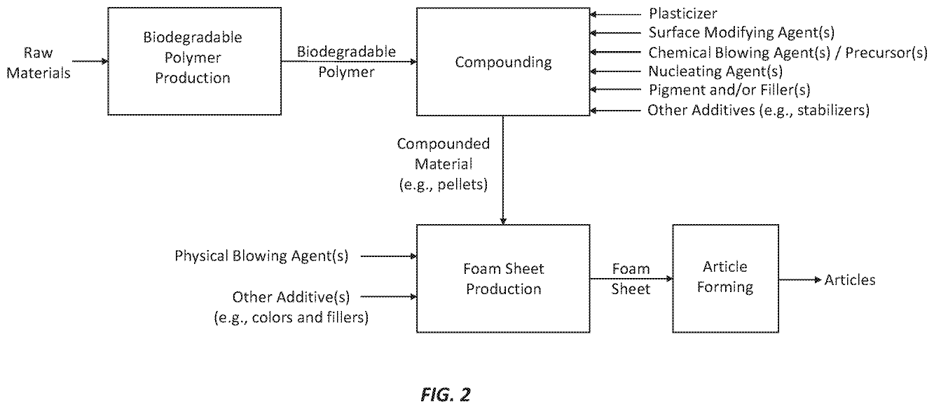

As shown in FIG. 1 and FIG. 2, raw materials may be introduced to a biodegradable polymer production process, which produces a biodegradable polymer material. In one embodiment or in combination with any other embodiment mentioned herein, the biodegradable polymer material comprises one or more cellulose esters. The one or more cellulose esters may comprise cellulose acetates. In such embodiments, the raw materials may comprise a pulp, such as wood pulp and/or cotton pulp. The pulp may be a dissolving-grade pulp and/or a paper-grade pulp. The cellulose in the pulp may esterified, for example with an acetic acid, to form the biodegradable cellulose ester polymer, such as a cellulose acetate polymer.

The biodegradable polymer material may then be introduced into a compounding process, in which the biodegradable polymer material may be mixed with plasticizer, and optionally one or more other additives (e.g., stabilizers), and formed into a compounded material comprising plasticized biodegradable polymer. Other additives may also be mixed with the polymer and plasticizer. For example, as shown in FIG. 2, the other materials (additives) may include, but are not limited to, stabilizers, physical blowing agent(s), chemical blowing agent(s) (and/or precursors), nucleating agent(s), surface modifying additive(s), pigment(s), filler(s), and/or other additive(s). Mixing can be accomplished by any known mixing technique, including, but not limited to, rolling in a cylindrical container, overhead stirring, sigma blade mixing, and tumbling.

The compounding process may include a particulating process. The particulating process may generally comprise mixing the biodegradable polymer material, plasticizer, and other additive(s) to form a mixed composition and forming particulate material from the composition. In particular, the particulating process may include a pelletization process, and the particulate material may comprise a quantity of pellets. The term “compounded CE material” means cellulose ester material formed during the compounding process, which may include a mixture of cellulose ester, plasticizer, and other additives. Further such compounded CE material may be in the form of particulate material or pellets. It should be understood that, as used herein, the phrases “particulating” or “particulating processes” may be the same as, or may at least include, “pelletizing” or “pelletizing processes.” In some embodiments, the particulating process may include pelletizing into a water bath, pelletizing on an air cooled belt, underwater pelletizing, solvent compounding, etc.

In one embodiment or in combination with any other embodiment mentioned herein, the plasticizer and other additive(s) may be mixed with cellulose esters by conventional melt compounding techniques, which involve combining the cellulose ester with plasticizer, and optionally the other additives, in a twin screw extruder with appropriate mixing elements and at appropriate temperatures and pressures to achieve a molten, homogeneously combined, cellulose ester mixture by the time the materials exit the extruder. The molten, compounded, cellulose ester mixture may then be extruded through a die with orifices that are about 2-6 mm in diameter so as to extrude a strand. This strand may then be cooled by water (e.g., via underwater pelletization) or air and cut at regular intervals to provide a uniform and desirable size and shape, referred to as “pellets” or “granules.” Although a process for forming pelletized compounded material is described herein, it will be understood that the compounded material fed to the foam sheet production process can be in any physical shape (e.g., pellets, powders, granules, fibers) in accordance with some embodiments. The term “compounded CE material” means cellulose ester material formed during the compounding process, which may include a mixture of cellulose ester, plasticizer, and other additives. Further such compounded CE material may be in the form of a molten mixture or a particulate material (e.g., pellets, powders, granules, fibers, etc.)

The compounded CE material, which as noted above may comprise pellets of plasticized biodegradable polymer, may then be introduced into a foam sheet production process, as illustrated in FIGS. 1 and 2. The foam sheet production process may include one or more zones/steps for producing a foam sheet or film, which are described in greater detail below. Although an exemplary foam sheet production process is described herein, it should be understood that certain aspects described herein may also be applicable to rigid (i.e., non-foamed) materials and articles. As shown in FIG. 1, in one embodiment or in combination with any other embodiment mentioned herein, various additives may be introduced to one or more zones of the foam sheet production process. The additives may include, but are not limited to, stabilizers, physical blowing agent(s), chemical blowing agent(s) (and/or precursors), nucleating agent(s), surface modifying additive(s), pigment(s), filler(s), and/or other additive(s).

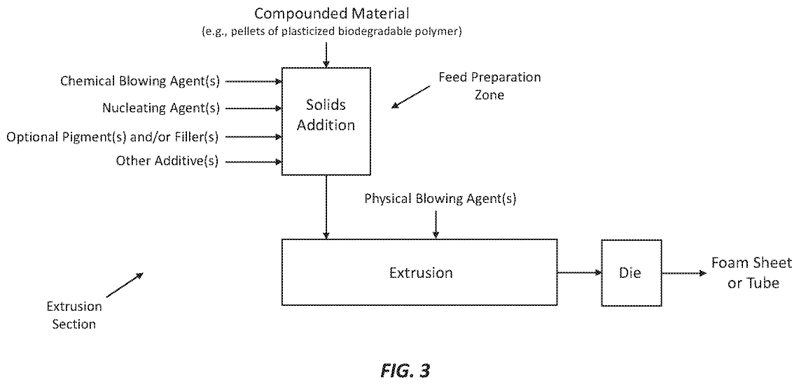

The foam sheet production process may generally include an extrusion section and a sheet forming section. An exemplary extrusion section is depicted in FIG. 3. As shown, the extrusion section may comprise a feed preparation zone, in which solid additives may be combined with the compounded CE material and introduced to the downstream extrusion zone. In one embodiment or in combination with any other embodiment mentioned herein, the feed preparation zone may comprise a feed hopper. Thus, the compounded CE material and the other solid additives may be deposited into the feed hopper, which directs the combined feed composition into the extrusion zone. The feed preparation zone may further comprise a mixer, in which the compounded CE material and one or more additive(s) may be mixed before being introduced to the hopper. Mixing can be accomplished by any known mixing technique, including, but not limited to, rolling in a cylindrical container, overhead stirring, sigma blade mixing, and tumbling. Exemplary solid additive(s) that can be combined with the compounded material may include chemical blowing agent(s), nucleating agent(s), surface modifying additive(s), pigment(s), filler(s), and/or other additive(s).

The combined feed composition from the feed preparation zone may then be introduction to the extrusion zone. The extrusion zone may generally comprise one or more extruders, which may include single screw and/or twin screw extruders. Within the extruder(s), the feed composition may be introduced into an extruder barrel and conveyed, via the screw(s), through a die, which forms an extrudate from the feed composition. The composition may be heated, and at least partially melted, as it is conveyed through the extruder barrel toward the die. Thus, the term “CE melt composition” is used herein to mean the cellulose ester-based feed composition that has been melted into a flowable, molten resin via the extrusion section. Heating may be supplied by external heaters positioned along the outside of the extruder barrel. The shape of the extrudate will generally depend on the shape and size of the die head. The extrudate may be further shaped by downstream processes, as described below.

One or more additive(s) may be introduced to the CE melt resin while in the extruder. For example, one or more physical blowing agent(s) may be added to the CE melt resin by injecting the physical blowing agent into the composition being conveyed within the extruder barrel.

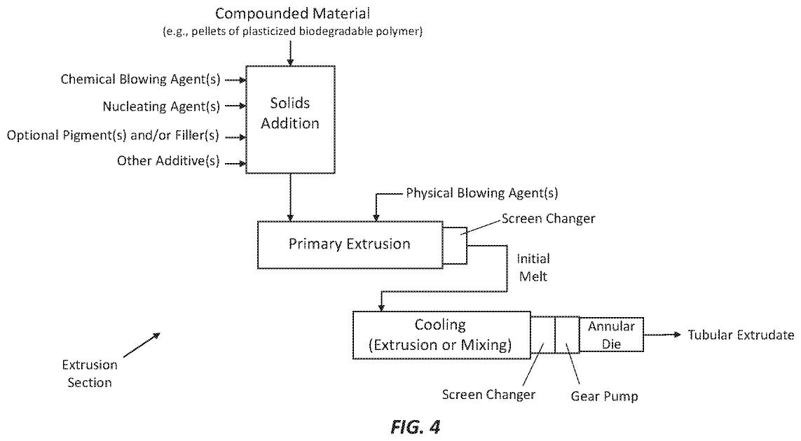

As depicted in FIG. 4, in one embodiment or in combination with any other embodiment mentioned herein, the extrusion zone may comprise a primary extrusion vessel and a cooling vessel. The primary extrusion vessel and cooling vessel may be separate devices or combined as a unitary apparatus. Regardless, the feed composition from the feed preparation zone is introduced into the primary extrusion vessel and at least partially melted as it is conveyed through the extruder barrel, as described above, to thereby produce the CE melt resin. The CE melt resin exiting the primary extrusion vessel may have a temperature from about 220° C. to about 240° C. One or more additives, such as blowing agent(s), may be added to the CE melt resin as it is conveyed through the primary extrusion vessel.

The CE melt resin from the primary extrusion vessel is then introduced into the cooling vessel. The cooling vessel may be a secondary extrusion vessel, which operates similarly to, but at a lower temperature than, the primary extrusion vessel. Within the cooling vessel, the CE melt resin may be further mixed to provide a substantially homogenous mixture of the melted polymer and other additive(s). The CE melt resin may then be directed through the die and out of the die head to provide a cellulose ester-based extrudate, which may be further processed in the sheet forming section of the foam sheet production process. In one embodiment or in combination with any other embodiment mentioned herein, the CE melt resin exiting the die head may have a temperature of at least 150° C., at least 160° C., at least 170° C., at least 180° C., at least 190° C., at least 200° C., from about 150° C. to about 220° C., and/or from about 170° C. to about 200° C.

As shown in FIG. 4, one or more filtration devices may be installed within the extrusion section to filter and remove particulate matter from the CE melt resin. For example, screen changer filtration devices may be installed at the downstream end of the primary and secondary extrusion vessels, which may remove solid components from the CE melt resin before directing the CE melt resin through the die head to the sheet forming section.

The sheet forming section may include any of a variety of systems and processes for shaping the extrudate into sheets of cellulose ester material that may be used in article formation. The shape of the extrudate will generally depend on the shape of the die head, while the shape of the sheets formed in the sheet forming section can depend on the shape of the die head and other downstream processes. For example, the extrudate may have a generally flat shape, or it may be annular and subjected to further processing to form a flat sheet. In embodiments in which the die has an annular shape, the die may have a diameter from 1 to 40 cm, from 2 to 20 cm, 2 to 10 cm, and/or 3 to 8 cm. Furthermore, the thickness of the opening from which extrudate is ejected, which is referred to herein as a “die gap,” may generally be sized from 0.1 to 6.0 mm, from 0.1 to 3.0 mm, and/or from 0.1 to 1.0 mm.

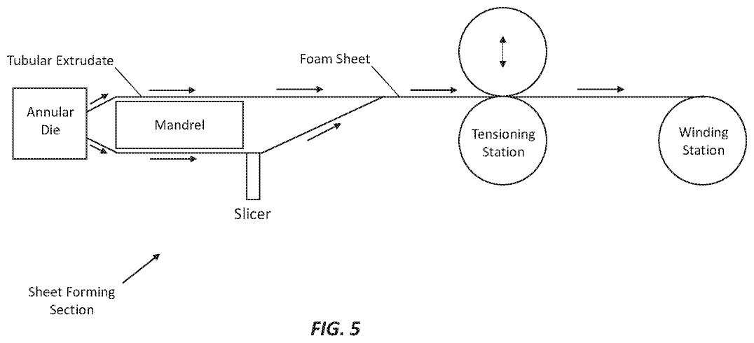

An exemplary sheet forming section is depicted in FIG. 5. As shown, the CE melt resin is extruded through an annular die and drawn over a forming mandrel. A cooling fluid (e.g., air) may be flowed across the interior and/or exterior of the extrudate to cool the extrudate material as it passes over the mandrel. For example, the cooling fluid may be blown from the mandrel toward the die to cool the interior surface of the extrudate between the die and mandrel. Additionally or alternative, the cooling fluid may be flowed across the mandrel to cool the exterior surface of the extrudate as it passes over the mandrel.

A slicer (or slitting device) may be used to open the tubular extrudate, which allows the tubular shape to be formed into a flat sheet. For example, the tubular extrudate passing over the mandrel may be slit and drawn to a tensioning station comprising one or more rollers that flatten the extrudate and maintain a necessary amount of tension on the extrudate to continue pulling the extrudate over the mandrel. The flattened extrudate will generally be in the form of a sheet, which may then be directed to a winding station where the material may be rolled for packaging and transportation.

Referring again to FIG. 1 and FIG. 2, the sheets produced by the sheet production process may be used to form foam articles, which are described in greater detail below. Such articles are particularly useful in the food service industry. Exemplary articles include meat trays. The articles may have one or more particularly advantageous properties. For example, the articles may be biodegradable and/or compostable, and/or the articles may have superior mechanical properties (e.g., strength, density, cell size, absorption, etc.).

### Compositions

The processes described above may comprise the preparation and extrusion of compositions that may be used for downstream processing to form useful articles. For example, in one embodiment or in combination with any other embodiment mentioned herein, the extrusion feed material may comprise a particulate material comprising a biodegradable polymer, a plasticizer, and optionally one or more additive(s), such as those described herein. In one embodiment or in combination with any other embodiment mentioned herein, the feed material may be combined with one or more additive(s), such as those described herein, to provide a mixed composition comprising the biodegradable polymer, the plasticizer, and the one or more additive(s). In one embodiment or in combination with any other embodiment mentioned herein, the biodegradable polymer comprises cellulose ester. Additional details of the composition components, including biodegradable polymers (e.g., cellulose esters), plasticizers, and other additives, are provided below.

### Cellulose Ester

The cellulose esters utilized as described herein can be any that is known in the art. Cellulose ester that can be used for embodiments herein generally comprise repeating units of the structure:

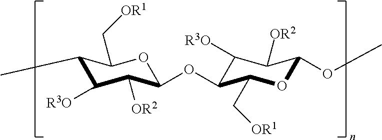

wherein R¹, R², and R³ are selected independently from the group consisting of hydrogen acetyl, propyl or butyl. The substitution level of the cellulose ester is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl or acetyl. In one embodiment or in combination with any other embodiment, n is an integer in a range from 25 to 250, or 25 to 200, or 25 to 150, or 25 to 100, or 25 to 75.

In one embodiment or in combination with any other embodiment, the cellulose esters have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose ester. In one embodiment or in combination with any other embodiment, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In one embodiment or in combination with any other embodiment, cellulose esters useful herein can have a DS/AGU of about 1 to about 3.0, of about 2.2 to about 2.8, or 1 to less than 2.2, or 1 to less than 1.5, and the substituting ester is acetyl.

Cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substituents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In one embodiment or in combination with any other embodiment, the cellulose acetate composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose esters useful in the present invention can be prepared using techniques known in the art, and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ Cellulose Acetate CA 398-10, Eastman™ CAP 485-20 cellulose acetate propionate; Eastman™ CAB 381-2 cellulose acetate butyrate.

In one embodiment or in combination with any other embodiment, the cellulose ester can be prepared by converting cellulose to a cellulose ester with reactants that are obtained from recycled materials, e.g., a recycled plastic content syngas source. In one embodiment or in combination with any other embodiment, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose ester composition comprising at least one recycle cellulose ester is provided, wherein the cellulose ester has at least one substituent on an anhydroglucose unit (AU) derived from recycled content material, e.g., recycled plastic content syngas.

In one embodiment or in combination with any other embodiment, the cellulose ester composition comprises cellulose ester in an amount from 50 to 99 wt %, or 60 to 99 wt %, or 70 to 99 wt %, or 80 to 99 wt %, or 90 to 99 wt %, 50 to 90 wt %, or 60 to 90 wt %, or 70 to 90 wt %, or 80 to 90 wt %, or 90 to 99 wt %, or 50 to 80 wt %, or 60 to 80 wt %, or 70 to 80 wt %, or 50 to 70 wt %, or 60 to 70 wt %, or 50 to 60 wt %, all based on the total weight of the cellulose ester composition. In some embodiments, the cellulose ester used herein may comprise a combination, blend, or mixture of two or more different types of cellulose esters. For example, in some embodiments, the cellulose esters used herein may be comprised of a blend of two or cellulose esters having differing DSACs; however, the blend may have an total DSAC of between 2.2 and 2.8

### Plasticizer

In one embodiment or in combination with any other embodiment, the cellulose ester compositions described herein can comprise at least one plasticizer. The plasticizer reduces the melt temperature, i.e., the Tg, and/or the melt viscosity of the cellulose ester. Plasticizers for cellulose esters may include glycerol triacetate (Triacetin), glycerol diacetate (Diacetin), dibutyl terephthalate, dimethyl phthalate, diethyl phthalate, poly(ethylene glycol) MW 200-600, dibutyl tartrate, di-2-methoxyethyl phthalate, ethyl o-benzoylbenzoate, triethylene glycol dipropionate, 1,2-epoxypropylphenyl ethylene glycol, 1,2-epoxypropyl(m-cresyl) ethylene glycol, 1,2-epoxypropyl(o-cresyl) ethylene glycol, β-oxyethyl cyclohexenecarboxylate, bis(cyclohexanate) diethylene glycol, triethyl citrate, polyethylene glycol, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, the benzoate containing plasticizers such as the Benzoflex™ plasticizer series, poly (alkyl succinates) such as poly (butyl succinate), polyethersulfones, o-Cresyl p-toluenesulfonate, n-ethyltoluenesulfonamides, adipate based plasticizers, soybean oil epoxides such as the Paraplex™ plasticizer series, sucrose based plasticizers, dibutyl sebacate, tributyrin, sucrose acetate isobutyrate, the Resolflex™ series of plasticizers, triphenyl phosphate (TPP), triethyl phosphate (TEP), glycolates (e.g., ethyl phthalyl ethyl glycolate “EPEG” and methyl phthalyl ethyl glycolate “MPEG”), methoxy polyethylene glycol, 2,2,4-trimethylpentane-1,3-diyl bis(2-methylpropanoate), and polycaprolactones. In some embodiments, the plasticizer used herein may comprise a combination or mixture of two or more different types of plasticizers.

In one embodiment or in combination with any other embodiment, the plasticizer is a food-compliant plasticizer. By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA. In one embodiment or in combination with any other embodiment, the food-compliant plasticizer is triacetin or polyethylene glycol (PEG) having a molecular weight of about 200 to about 600. In one embodiment or in combination with any other embodiment, examples of food-compliant plasticizers that could be considered can include triacetin, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate.

In one embodiment or in combination with any other embodiment, the plasticizer can be present in an amount sufficient to permit the cellulose ester composition to be melt processed (or thermally formed) into useful articles, e.g., single use plastic articles, in conventional melt processing equipment. In one embodiment or in combination with any other embodiment, the plasticizer is present in an amount from 1 to 40 wt % for most thermoplastics processing; or 5 to 25 wt %, or 10 to 25 wt %, or 12 to 20 wt % based on the weight of the cellulose ester composition. In one embodiment or in combination with any other embodiment, profile extrusion, sheet extrusion, thermoforming, and injection molding can be accomplished with plasticizer levels in the 10-30, or 12-25, or 15-20, or 10-25 wt % range, based on the weight of the cellulose ester composition.

In one embodiment or in combination with any other embodiment, the plasticizer is a biodegradable plasticizer. Some examples of biodegradable plasticizers include triacetin, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, the Resoflex™ series of plasticizers, triphenyl phosphate, glycolates, polyethylene glycol, 2,2,4-trimethylpentane-1,3-diyl bis(2-methylpropanoate), and polycaprolactones.

In one embodiment or in combination with any other embodiment, the cellulose ester composition can contain a plasticizer selected from the group consisting of PEG and MPEG (methoxy PEG). The polyethylene glycol or a methoxy polyethylene glycol composition having an average molecular weight of from 200 Daltons to 600 Daltons, wherein the composition is melt processable, biodegradable, and disintegrable.

In one embodiment or in combination with any other embodiment, the composition comprises polyethylene glycol or methoxy PEG having an average molecular weight of from 300 to 550 Daltons.

In one embodiment or in combination with any other embodiment, the composition comprises polyethylene glycol having an average molecular weight of from 300 to 500 Daltons.

In one embodiment or in combination with any other embodiment, the cellulose ester composition comprises at least one plasticizer (as described herein) in an amount from 1 to 40 wt %, or 5 to 40 wt %, or 10 to 40 wt %, or 12 to 40 wt %, 13 to 40 wt %, or 15 to 40 wt %, or greater than 15 to 40 wt %, or 17 to 40 wt %, or 20 to 40 wt %, or 25 to 40 wt %, or 5 to 35 wt %, or 10 to 35 wt %, or 13 to 35 wt %, or 15 to 35 wt %, or greater than 15 to 35 wt %, or 17 to 35 wt %, or 20 to 35 wt %, or 5 to 30 wt %, or 10 to 30 wt %, or 13 to 30 wt %, or 15 to 30 wt %, or greater than 15 to 30 wt %, or 17 to 30 wt %, or 5 to 25 wt %, or 10 to 25 wt %, or 13 to 25 wt %, or 15 to 25 wt %, or greater than 15 to 25 wt %, or 17 to 25 wt %, or 5 to 20 wt %, or 10 to 20 wt %, or 13 to 20 wt %, or 15 to 20 wt %, or greater than 15 to 20 wt %, or 17 to 20 wt %, or 5 to 17 wt %, or 10 to 17 wt %, or 13 to 17 wt %, or 15 to 17 wt %, or greater than 15 to 17 wt %, or 5 to less than 17 wt %, or 10 to less than 17 wt %, or 13 to less than 17 wt %, or 15 to less than 17 wt %, all based on the total weight of the cellulose ester composition.

In one embodiment or in combination with any other embodiment, the at least one plasticizer includes or is a food-compliant or FDA approved plasticizer. In one embodiment or in combination with any other embodiment, the food-compliant or FDA approved plasticizer includes or is triacetin or PEG MW 300 to 500.

### Biodegradable Polymers

In one embodiment or in combination with any other embodiment, the cellulose ester compositions described herein comprise a biodegradable cellulose ester (BCE) component that comprises at least one BCE, which may include one or more of the cellulose esters described herein, and a biodegradable polymer component that comprises at least one other biodegradable polymer (other than the BCE). In one embodiment or in combination with any other embodiment, the other biodegradable polymer can be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In one embodiment or in combination with any other embodiment, the cellulose ester composition comprises two or more biodegradable polymers. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the cellulose ester composition. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the total amount of BCE and biodegradable polymer. In one embodiment or in combination with any other embodiment, the at least one biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In one embodiment or in combination with any other embodiment, the PHA can include a polyhydroxybutyrate-co-hydroxyhexanoate.

### Nucleating Agent

Nucleating agent means a chemical or physical material that provides sites for cells to form in a molten formulation mixture, such as within a CE melt resin. As will be described in more detail below, nucleating agents may be added to compounded CE material during the compounding process. Alternatively, or in addition, nucleating agents may be added during the foam sheet production process. For example, the nucleating agents may be blended with the formulation that is introduced into the hopper of the extruder of the extruding section. Alternatively, the nucleating agents may be added to the CE melt resin in the extruder itself. Nucleating agents may include physical nucleating agents and chemical nucleating agents. Physical nucleating agents are materials that are immiscible with the polymer matrix of the CE melt resin at the extrusion temperature of the extrusion section. Chemical nucleating agents are materials that react (e.g., decompose) during extrusion (e.g., at the extrusion temperature within the extruder) to form physical nucleating agents. Thus, chemical nucleating agents may be considered (and referred to herein as) precursors of in situ formed physical nucleating agents.

Suitable physical nucleating agents will comprise fine particles having desirable particle sizes and/or shapes to create cell nucleation sites within the CE melt resin. For example, in some embodiments, physical nucleating agents will have a mean particle size of less than 1000 microns, less than 500 microns, less than 100 microns, less than 50 microns, less than 25 microns, less than 20 microns, less than 10 microns, less than 5 microns, less than 2 microns, less than 1.5 microns, and/or less than 1.0 microns. However, in some other embodiments, it may be preferred to have nanoscale-sized particles. Furthermore, it some embodiments, physical nucleating agents will preferably have a high aspect ratio (i.e., width:height). For example, in some embodiments, physical nucleating agents will have a mean aspect ratio of greater than 1:1, greater than 2:1, greater than 5:1, greater than 10:1, greater than 20:1, greater than 30:1, greater than 40:1, greater than 50:1, greater than 75:1, and/or greater than 100:1. Furthermore still, as noted above, physical nucleating agents should be immiscible with the polymer matrix of the CE melt resin at the extrusion temperature of the extrusion section. As such, in some embodiments, the physical nucleating agents should have a melting temperature at least 220° C., at least 230° C. of at least 240° C., at least 250° C., at least 275° C., at least 300° C., at least 325° C., or at least 350° C. Nevertheless, the physical nucleating agents may be selected such that they have the ability to, after melting, recrystallize upon cooling.

Examples of suitable inorganic physical nucleating agents include, but are not limited to, minerals such as talc, CaCO₃, mica, and mixtures of at least two of the foregoing. One representative example is Heritage Plastics HT6000 Linear Low Density Polyethylene (LLDPE) Based Talc Concentrate. Other inorganic physical nucleating agents include wollastonite, silica, silicon oxide, titanium oxide, magnesium oxide, aluminum oxide and calcium silicate, barium sulfate, Kaolin, aluminum trihydrate ATH (Al(OH)₃), MDH (Mg(OH)₂), Diatomaceous earth, magnetite/hematite, halloysite, zinc oxide, and titanium dioxide. In some embodiments, the inorganic nucleating agents will comprise oxides, such as metal oxides or mixed metal oxides, such as those selected from one or more of the following: aluminum oxide, antimony oxide, arsenic oxide, bismuth oxide, boron oxide, calcium oxide, gallium oxide, iron oxide, lithium oxide, magnesium oxide, silicon oxide, and titanium oxide. In other embodiments, the inorganic nucleating agents will comprise silicates, such as silicates selected from one or of the following: magnesium silicate and calcium silicate.

It has been discovered that biodegradable natural, particulate materials derived from renewable organic sources (e.g., organic nucleating agents) can also serve as effective physical nucleating agents. Natural materials that can be physical nucleating agents include material comprised of cellulose fibers and/or cellulose starch. Examples include, but are not limited to almond shell flour, animal fiber, apricot shell flour, bamboo flour, tree bark flour, clam shell flour, coconut shell flour, coconut coir, cork flour, corn cob flour, corn cob grit, cottonseed hulls, flock & fiber, hazelnut shell flour, kenaf flour, natural fibers, nutshell hull & flour, oat fiber powder, olive stone flour, peanut hulls flour, pecan shell flour, pine-nut shell powder, pistachio-nut shell flour, plant fiber, rice hull flour, rice hull grit, rice husk, soy bean flour, starch flour (hydrophobic), walnut shell flour, wheat chaff, wheat husk, and wood flour. Other organic physical nucleating agents include cellulose powder, chitin, chitosan, stearic acid metal salts, carbon black, and dolomite.

As noted above, suitable chemical nucleating agents (or precursors of in situ formed physical nucleating agents) are configured to decompose to create cell nucleation sites in the CE melt resin when a threshold chemical reaction temperature is reached. These small cells act as nucleation sites for larger cell growth from a physical or other type of blowing agent. In some embodiments, the precursors are configured to form a gas during extrusion of the particulate material, such as CO₂ or N₂.

Examples of chemical nucleating agents include but are not limited to acids, such as citric acid or a citric acid-based material. Other acids may include lauric acid, stearic acid, tartaric acid, ascorbic acid, propionic acid, and hexanoic acid. One representative example is HYDROCEROL™ CF-40E (available from Clariant Corporation), which contains citric acid and a crystal nucleating agent. In some embodiments, the chemical nucleating agents will include a combination of an acid and a base, such as a carbonate, which may include sodium bicarbonate, zinc bicarbonate, potassium bicarbonate, sodium carbonate, potassium carbonate, etc. For instance, a representative example of a chemical nucleating agent is a combination of citric acid and sodium bicarbonate. In some embodiments, chemical nucleating agents may include a carrier within which the active components of the nucleating agents are dispersed. For example, yet another representative example of chemical nucleating agents is a combination of citric acid, sodium bicarbonate, and a carrier. In some embodiments, the carrier may comprise polystyrene. However, the carrier may comprise other compositions, such as various biopolymers (e.g., polybutylene succinate, Capa polyesters, etc.), polyolefins, acrylic copolymers (e.g., ethylene methyl acrylate), or the like. In some such embodiments, the citric acid and sodium bicarbonate may comprise about half (in wt %) of the chemical nucleating agents, while the carrier makes up the remaining half (in wt %). Furthermore, in some of such embodiments, there may be more sodium bicarbonate than citric acid in the chemical nucleating agent. For instance, there may be about three times as much (in wt %) sodium bicarbonate than citric acid in the chemical nucleating agent. It should also be understood that in some embodiments, no carrier may be required or used, such as the case with the nucleating agent being Hecofoam or Hydrocerol.

In one embodiment or in combination with any of the embodiments mentioned herein, the nucleating agents are present at from 0.1 to 10 wt %, from 0.1 to 5.0 wt %, at least 0.1 wt %, at least 0.25 wt %, at least 0.5 wt % at least 1.0 wt %, at least 1.25 wt %, at least 1.5 wt %, at least 1.75 wt %, at least 2.0 wt %, at least 2.25 wt %, at least 2.5 wt %, at least 2.75 wt %, or at least 3.0 wt %, or at least 3.5 wt %, or at least 4.0 wt %, or at least 4.5 wt % and/or less than 7.5 wt %, less than 5 wt %, less than 4 wt %, less than 3 wt %, less than 2 wt %, or less than 1.0 wt %, all based on the total weight of the cellulose ester composition. In some embodiments, the nucleating agents used herein may comprise a combination or mixture of two or more different types of nucleating agents.

It is noted that the cellulose ester material, whether in the form of compounded CE material or CE melt resin, will generally be able to accept a maximum amount of nucleating agent that can function to form nucleation sites. Any remaining nucleating agent that is added to the cellulose ester material will remain as filler. Fillers can provide various properties to the resulting cellulose ester foams and/or articles based on the type of filler used. For example, some fillers can provide increased/decreased density, ductility, Young's modulus, yield strength, heat deflection temperature, permeability, impact resistance, elongation to break, adhesion properties, biodegradation, etc. of the cellulose ester material. Fillers can also be used to alter the visual characteristics (e.g., color, opacity, etc.) and tactile characteristics (e.g., material continuous, surface roughness, etc.) of the cellulose ester material.

### Blowing Agents

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agents function to reduce density of a material by expanding cells formed in the molten formulation at the nucleation sites. The blowing agent may be added to the CE melt resin in the extruder. It has been surprisingly discovered that the hygroscopic nature of biodegradable particulate natural fillers allows them to absorb moisture and carry the absorbed water into the molten resin mixture where the water can act as a physical blowing agent.

Examples of physical blowing agents include H₂O, N₂, CO₂, alkanes, alkenes, ethers, ketones, argon, helium, air or mixtures. In addition, it has been surprisingly discovered that the hygroscopic nature of biodegradable particulate natural fillers allows them to absorb moisture and carry the absorbed water into the molten resin mixture where the water can act as a physical blowing agent. Hygroscopic biodegradable natural fillers can be formulated into a composition and allowed to absorb moisture prior to the foaming process, where the water then is released to act as a physical blowing agent. Beneficially, the water may also be used as a plasticizer for the cellulose ester resin. Furthermore, in some embodiments, physical blowing agents may include hydrocarbons, such as pentane/isopentane or butane/isobutane. Other hydrocarbons may include propane, ethane, methane, hexane, cyclohexane, cyclopentane, cyclobutene, or the like.

Chemical blowing agents are materials that degrade or react to produce a gas (e.g., CO₂ or N₂). Such gasses expand the cells within the molten resin mixture and/or resulting foam mixture to produce a structural material with a plurality of gaseous voids dispersed throughout. Chemical blowing agents may be endothermic or exothermic. Chemical blowing agents typically degrade at a certain temperature to decompose and release gas. Examples of chemical blowing agents include azodicarbonamide, acids (e.g., citric acid), and carbonates, such as sodium bicarbonate, sodium carbonate, ammonium bicarbonate, ammonium carbonate, zinc carbonate, and the like and combinations thereof.

In one embodiment or in combination with any of the embodiments mentioned herein, the blowing agent is present at from 0.3 to 1.5 wt %, or 0.3 to 2.0 wt %, or 0.3 to 2.5 wt %, or 0.3 to 3.0 wt %, or 0.3 to 3.5 wt %, or 0.3 to 4.0 wt %, or 0.3 to 8%, or 1.3 to 1.5 wt %, or 1.3 to 2.0 wt %, or 1.3 to 2.5 wt %, or 1.3 to 3.0 wt %, or 1.3 to 3.5 wt %, or 1.3 to 4.0 wt %, or 1.3 to 4.5 wt %, or 1.3 to 5.0 wt %, or 1.3 to 5.5 wt %, or 1.5 to 3.0 wt %, or 1.5 to 4.0 wt %, or 1.5 to 5.0 wt %, or 1.5 to 6.0 wt %, or 2.0 to 3.0 wt %, or 2.0 to 4.0 wt %, or 2.0 to 5.0 wt %, or 2.0 to 6.0 wt %, or 2.5 to 3.0 wt %, or 2.5 to 4.0 wt %, or 2.5 to 5.0 wt %, or 2.5 to 6.0 wt %, or 3.0 to 4.0 wt %, or 3.0 to 5.0 wt %, or 3.0 to 6.0 wt %, or 0.0 to 9.0 wt %, or 0.5 to 9.0 wt %, or 1.0 to 9.0 wt %, or 1.5 to 9.0 wt %, or 2.0 to 9.0 wt %, or 2.5 to 9.0 wt %, or 3.0 to 9.0 wt %, or 3.5 to 9.0 wt %, or 4.0 to 9.0 wt %, or 4.5 to 9.0 wt %, or 5.0 to 9.0 wt %, or 5.5 to 9.0 wt %, or 6.0 to 9.0 wt %, or 6.5 to 9.0 wt %, or 7.0 to 9.0 wt %, or 7.5 to 9.0 wt %, or 8.0 to 9.0 wt %, or 8.5 to 9.0 wt %, all based on the total weight of the cellulose ester composition. In some embodiments, the blowing agents used herein may comprise a combination or mixture of two or more different types of blowing agents.

### Surface Modifying Additives

Surface modifying additives refer to materials that can be added to cellulose ester compositions to modify the structure of the compositions (or the resulting foam articles) to improve processing of the cellulose ester compositions. For example, the inventors of the present application have found that adding surface modifying additives to the compounded CE material (e.g., to the pellets during the compounding process) or to the CE melt resin (e.g., during the extrusion process) can improve processing by reducing unwanted sticking of the CE melt resin to the die or mandrel (or to other components of the foam sheet production process). Such reduction in sticking may be achieved by the surface modifying additives inhibiting the fusing of cellulose esters caused by plasticizers. The addition of surface modifying additives may also reduce blocking of the cellulose ester foam sheets produced at the sheet forming section. Furthermore, surface modifying additives may also improve the foam sheet production process by allowing the process to be performed at lower temperatures.

Furthermore still, in some embodiments, the surface modifying additives may function as anti-static additives, which inhibit electrical sparks or arcing in the CE melt resin. The inhibition of electrical sparks or arcing can be particularly important when hydrocarbons are used as blowing agents, so as to reduce the chance of igniting the hydrocarbons and causing fires. Beneficially, surface modifying additives may also reduce the diffusion of blowing agents, such as hydrocarbons, out of the foam sheets or resulting articles. In some embodiments, hydrocarbons themselves may be used as surface modifying additives.

Nevertheless, more general examples of surface modifying additives that may be used with compounded CE material (e.g., during the compounding process) or to the CE melt resin (e.g., during the foam sheet production process) according to embodiments of the present invention include fatty acids, such as palmitic acid, tallow acid, stearic acid, oleic acid, linoleic and linolenic acids, arachidic/behenic acids, behenic acid, and erucic acid. Surface modifying additives may also include fatty acid amides, such as erucamides, oleoamides, stearmides, bhenamides, secondary amides, and bisamides.

Additional examples of surface modifying additives may include glycerol esters and/or stearate esters, such as monoglycerides, diglycerides, and triglycerides. The monoglycerides may include glycerol monostearate or monoglyceride derivatives, such as diacetyl tartaric acid esters of mono- and diglycerides (DATEM), ethoxylated monoglyceride, succinyl monoglyceride, and propylene glycol monoesters (PGME). Examples of surface modifying additives may also include metallic stearates such as aluminum stearate, calcium stearate, lithium stearate, magnesium stearate, sodium stearate, zinc stearate, and/or combinations thereof (e.g., Calcium/Zinc stearates). Examples of surface modifying additives may also include waxes, such as polyolefin waxes (polypropylene wax and polyethylene wax), oxidized olefin waxes, ethylene acrylic acid (EAA) copolymer waxes, ethylene methyl acrylate (EMA) copolymer waxes, EAA ionomer axes, acrylic waxes, and/or natural waxes, such as rice bran wax, sunflower wax, sugar cane wax, candelilla wax, soy wax, bees wax, candelilla wax, and carnauba waxes.

Other, non-exclusive examples of surface modifying additives include aliphatic diesters (e.g., dioctyl adipate), polyglycol diesters, alkyl alkyether diesters, aromatic triesters, polyester resins, chlorinated hydrocarbons, halogenated hydrocarbons, alkylether monoesters, and alkyl monoesters. In addition, various oils may be used as surface modifying additives, such as aromatic oils, napthenic oils, glyceride oils, silicon oils, and epoxidized oils (e.g., soybean oil and linseed oil). Thus, in some embodiments, the surface modifying additives comprise plasticizers, such as aliphatic diester plasticizers, polyester plasticizers, and the like. Furthermore, in some embodiments, surface modifying additives may comprise a polyhedral oligomeric silsesquioxane (POSS).

More generally, surface modifying additives used in embodiments of the present invention may have a lower polarity than the cellulose ester in compounded CE material (e.g., during the compounding process) or to the CE melt resin (e.g., during the foam sheet production process). For example, the surface modifying additives may have (based on Hansen solubility parameters): a total solubility parameter δ of less than 25 MPa^{1/2}, less than 20 MPa^{1/2}, or less than 19.5 MPa^{1/2}; a dispersion force solubility parameter δ_{d} of less than 18 MPa^{1/2}, less than 16 MPa^{1/2}, or less than 14 MPa^{1/2}; a dipolar intermolecular force solubility parameter δ_{d} of less than 12 MPa^{1/2}, less than 8 MPa^{1/2}, or less than 4 MPa^{1/2}; and/or a hydrogen bond solubility parameter δₕ of less than 11 MPa^{1/2}, less than 10 MPa^{1/2}, or less than 9 MPa^{1/2}. However, in some other embodiments, the surface modifying additives used in embodiments of the present invention may have a higher polarity than the cellulose ester in compounded CE material (e.g., during the compounding process) or to the CE melt resin (e.g., during the foam sheet production process). For example, the surface modifying additives may have (based on Hansen solubility parameters): a total solubility parameter δ of more than 21.5 MPa^{1/2}, more than 23 MPa^{1/2}, or more than 25 MPa^{1/2}. In addition, in some embodiments, surface modifying additives may have a boiling point greater than 200° C., greater than 220° C., greater than 240° C., greater than 260° C., greater than 280° C., or greater than 300° C. Furthermore, the surface modifying additives may have a molecular weight greater than 100 g/mol, greater than 150 g/mol, greater than 220 g/mol, greater than 260 g/mol, greater than 300 g/mol, or greater than 340 g/mol and/or no more than 1000 g/mol, no more than 2500 g/mol, or no more than 5000 g/mol. Furthermore still, it may be preferable for the surface modifying additives to not be soluble in the plasticizer(s) used in the cellulose ester compositions. For instance, it may be preferable for the surface modifying additives to not be soluble in triacetin. Finally, in some embodiments, the surface modifying additives may be biodegradable and/or food-compliant or FDA approved.

In one embodiment or in combination with any of the embodiments mentioned herein, the surface modifying additives are present at from 0.05 to 0.75 wt %, or 0.05 to 1.0 wt %, or 0.05 to 2.5 wt %, or 0.05 to 5.0 wt %, or 0.75 to 1.0 wt %, or 0.75 to 2.5 wt %, or 0.75 to 5.0 wt %, or 0.1 to 1.0 wt %, or 0.1 to 2.5 wt %, 0.1 to 5.0 wt %, or 1.0 to 2.5 wt %, or 1.0 to 5.0 wt %, or 2.5 to 5.0 wt %, all based on the total weight of the cellulose ester composition. In some embodiments, the surface modifying additives used herein may comprise a combination or mixture of two or more different types of surface modifying additives.

### Articles

Extruded sheets of cellulose ester foam may be formed using the extrusion section and/or the sheet forming section described above. Such extruded sheets comprise a structural material with a plurality of gaseous voids disposed throughout. Such gaseous voids are formed by expansion of the blowing agent in the form of a gas within the cellulose polymer melt. The structural material is cellulose ester based, with specific amounts of the compositional components of the structural material (e.g., cellulose ester, plasticizer, nucleating agents, surface modifying additives, etc.) having been described above in more detail. Articles may be formed from the extruded sheets of foam in accordance with embodiments, and may be particularly useful in the food service industry. Exemplary articles include meat trays. The articles may have one or more particularly advantageous properties. For example, the articles may have preferential water absorption properties, be biodegradable and/or compostable, and/or the articles may have superior mechanical properties (e.g., strength, density, cell size, absorption, etc.).

Such cellulose ester foamed articles may be formed from cellulose ester foamed sheets by thermoforming, in which heat and optionally pressure are applied to the foamed sheet within a mold to create a three-dimensional article that retains its shape after release from the mold. For example, in some embodiments, the foamed sheets will be heated to a surface temperature from 40-100° C., from 50-80° C., or from 50-70° C. greater than the Tg of the foamed sheet. In some embodiments, the Tg of the foamed sheet will be about 120° C. As such, the thermoforming process may heat the foamed sheet to a surface temperature from 150-210° C. or from 160-200° C.

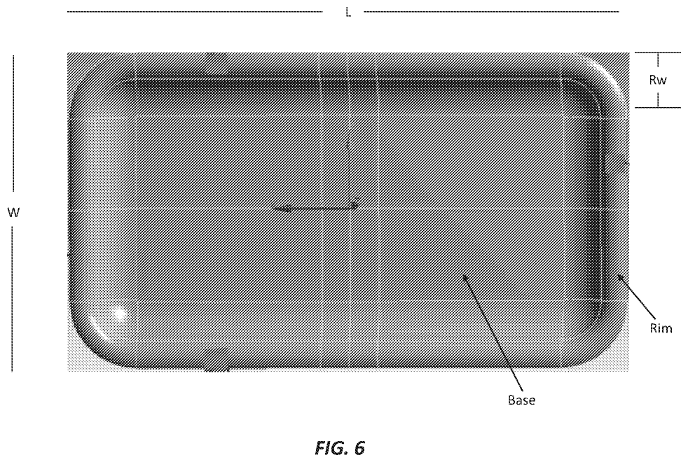

In more detail, embodiments of the present invention may include a foamed article in the form of a foamed tray, as illustrated in FIG. 6. The foamed tray may be configured as a food tray to support one or more food items such as meat. As illustrated, the foamed tray may include a base that is substantially planar, as well as a rim that is raised above the base and extends around the periphery of the foamed tray. The top surface of the base and the surrounding rim define a receiving area (e.g., a bowl) within which items (e.g., meat, cheese, vegetables, fruits, or other foodstuff) may be held and supported.

Foamed trays formed according to embodiments of the present invention may be formed in various sizes. For example, as illustrated in FIG. 6, the tray may have a width “W” in the range of 2-12 inches, 3-10 inches, or 5-9 inches and a length “L” from 4-24 inches, 5-18 inches, or 6-15 inches.

Thus, in some embodiments, the tray may have a length that is 1.2-4 times, 1.4-3 times, or 1.5-2 times the width of the tray. An area of the base may be from 5-100 square inches, 10-75 square inches, or 20-50 square inches. A rim heigh height (measured from a bottom of the tray to a top of the rim) may be from 0.2-4 inches, 0.4-2 inches, or 0.5-1 inch, and the rim width (i.e., a lateral distance “Rw” measured from a side of the tray to the point at which the rim meets the base, as illustrated in FIG. 6) may be from 0.06-0.75 inches, 0.10-0.05 inches, or 0.25-0.50 inches. Alternatively, the rim width “Rw” may be from about 0.01 W to 0.1 W or from about 0.03 W to 0.06 W, where “W” represents the width of the tray as discussed above. A ratio of the base area to the rim area may be from 1-10, 1.5-6, or 2-4. In addition, the tray may have a depth (measured from a top of the rim to the top surface of the base) from 0.3 to 4 inches, from 0.5 to 3 inches, from 1 to 3 inches, from 1 to 2 inches, from 1.25 to 2 inches, about 1.25 inches, or about 1.5 inches. Furthermore, the tray or other article may have a thickness (i.e., the thickness of the cellulose ester foam material) from 1 to 10 mm, from 1 to 8 mm, from 2 to 8 mm, from 3 to 7 mm, from 4 to 6 mm, about 4 mm, about 5 mm, or about 6 mm, and/or less than 5 mm, less than 4 mm, less than 3 mm, or less than 2 mm. Alternatively, or in addition, the tray or other article may have a thickness (i.e., the thickness of the cellulose ester foam material) from 100-400 mils, 120-300 mils, 150-250 mils.

Beneficially, the foamed tray may have preferential water absorption properties. For instance, when the foamed tray is used to support meat, it may be preferable for the tray to not to absorb liquid emitted from the meat. Foamed trays may be tested for water absorption (i.e., Moisture Absorption Test”), using the following test procedure, which includes the following steps: (1) weighing the foamed tray to obtain an original tray weight; (2) filling the receiving area of the tray with water until the water reaches the top of the rim; (3) allowing the water-filled foamed tray to equilibrate at room temperature for either one hour or overnight (i.e., eighteen hours); (4) emptying the tray of the water supported in the receiving area; (5) lightly wiping down the tray to remove any excess water remaining on the surface of the tray; (6) weighing the water-exposed tray to obtain a water-exposed tray weight; and (7) calculating the percentage weight gain of the water-exposed tray weight relative to the original tray weight. As used herein, a “One-Hour Water Absorption Test” is defined as the above-described procedure, with the equilibration step (3) being one hour. In addition, as used herein, an “Eighteen-Hour Water Absorption Test” is defined as the above-described procedure, with the equilibration step (3) being eighteen hours.

According to embodiments of the present invention, after an inventive tray is filled with water and allowed to equilibrate at room temperature for one hour (i.e., under the One-Hour Water Absorption Test), the tray (after removing the water from the receiving area of the tray) can have a weight gain of less than 10%, less than 9%, less than 8%, less than 7%, less than 6%, less than 5%, and/or less than 4%. Alternatively, or in addition, after an inventive tray is filled with water and allowed to equilibrate at room temperature overnight (i.e., under the Eighteen-Hour Water Absorption Test), the tray (after removing the water from the receiving area of the tray) may have a weight gain of less than 20%, less than 15%, less than 14%, less than 13%, less than 12%, less than 11%, and/or less than 10.5%.

After the One-Hour Water Absorption Test and/or the Eighteen-Hour Water Absorption Test, the foamed trays can further undergo a “Freeze-Thaw Test” to test the ability of the trays to absorb water after experiencing a freeze-thaw cycle. The Freeze-Thaw Test includes the following steps: (1) freezing the trays overnight (i.e., eighteen hours) within a freezer; (2) removing the frozen trays from the freezer; (3) leaving the frozen trays to thaw at room temperature overnight (i.e., eighteen hours); (4) filling the receiving area of the thawed foamed tray with water; (5) allowing the filled tray to equilibrate at room temperature for twelve hours; (6) emptying the tray of the water supported in the receiving area; (7) lightly wiping down the emptied tray to remove any excess water remaining on the surface of the tray; (8) weighing the water-exposed tray to obtain a water-exposed tray weight; and (9) calculating the percentage weight gain of the water-exposed tray weight relative to the original weight of the tray. According to embodiments of the present invention, after a tray has undergone the Eighteen-Hour Water Absorption Test and the Freeze-Thaw Test, the tray may have a weight gain of less than 30%, less than 25%, less than 20%, and/or less than 15%.

To enhance the ability of the foamed trays to minimize water absorption, a hydrophobic cap layer may be formed on the exterior surfaces of the foam trays. Such a hydrophobic cap layer may be formed by using a hydrophobic additive (e.g., stearic acid, calcium stearate, zinc stearate, glycerol monostearate, or the like) to the material used to form the cellulose ester foamed sheets. For instance, the hydrophobic additive may be added to the compounded CE material (e.g., during the compounding process) or to the CE melt resin (e.g., during the foam sheet production process). Alternatively, or in addition, the hydrophobic cap layer may be formed on the surface of the foamed article by coextruding, laminating, and/or coating a hydrophobic material onto the foamed sheet and/or onto the foamed article. Because, as discussed above, the foamed article may be used to support food items, such as meat, it may be beneficial for the hydrophobic cap layer to be formed on the upper surface of the foamed article that supports the foot item (e.g., on the surface of the foamed article and/or tray that forms the bowl or receiving area).

Several sample trays were formed and tested using the Water Absorption Tests and the Freeze-Thaw Test. The trays were formed from a cellulose ester foam sheet that was extruded using a tandem extruder system. The cellulose ester melt resin that was extruded comprised cellulose diacetate with a degree of substitution of 2.52, a melting point from 230-250° C., and a Tg of 189° C. The melt resin was plasticized with triacetin from 15 to 20 wt. % loading. Talc was used as a nucleating agent, which along with a physical blowing agent, was mixed into the melt resin within a twin screw extruder of the tandem extruder system. The resulting melt resin was transferred to a single screw extruder, with which an annular die was used to extrude a cellulose ester foam sheet. The foam sheet was stretched, cut, and thermoformed to form a foam tray. The results of four samples that underwent the One-Hour Water Absorption Test are shown in Table 1. The results of four samples that underwent the Eighteen-Hour Water Absorption Test are shown in Table 2, and the results of two samples that underwent the Freeze-Thaw Test are shown in Table 3. It is noted that for each sample, at least three foamed trays were used and the measurements were averaged to provide the show results shown below.

TABLE 1

| | Wt gain - 1 hour (%) |
|---|---|
| EX # | (average ± std. dev.) |
| 1 | 3.9 ± 0.3 |
| 2 | 6.5 ± 0.6 |
| 3 | 4.6 ± 0.2 |
| 4 | 6.3 ± 1.6 |

TABLE 2

| | Wt gain - Overnight (%) |
|---|---|
| Ex # | (average ± std. dev.) |
| 5 | 10.5 ± 0.3 |
| 6 | 11.8 ± 0.7 |
| 7 | 13.3 ± 0.7 |
| 8 | 13.3 ± 1.9 |

TABLE 3

| | Weight gain | Weight gain after |
|---|---|---|
| Ex # | overnight (%) | freeze thaw cycle (%) |
| 9 | 14.3 | 14.9 |
| 10 | 24.1 | 26.4 |

Embodiments provide for the above described foamed trays to be formed according to the processes described herein. In particular, a mixed composition comprising cellulose ester can be extruded through an extruder to form a cellulose ester foamed sheet. The foamed sheet can then be thermoformed to form a tray, which can include a generally planar base and a rim extending up from the base and around the periphery of the tray. The resulting foamed tray can be used to support food products, such as meat. Thus, in some embodiments, an absorbent pad will be placed on the top of the base, within the receiving area of the tray, such that liquid from the meat (or other foodstuff) can be absorbed by the pad. In addition, shrink film or overwrap film can be wrapped around the tray so as to securely hold the meat therein and to protect the meat from the environment. Beneficially, the trays described herein may be formed with preferential densities, which allow for the trays to be formed on an economically efficient basis. Such preferential densities may be achieved via post-expansion of the foam that occurs especially with the cellulose ester material used in the trays.

In more detail, and according to embodiments of the present invention, a foamed sheet may be produced, e.g., via extrusion, from a cellulose ester composition. The resulting foam sheet may have an extruded sheet density. Thereafter, the foamed sheet may be thermoformed to form a foamed article, such as food or meat tray. The resulting article may undergo a thermoforming post-expansion, such that the resulting article has an article density that is at least 20%, at least 30%, at least 40%, and/or at least 50% less dense than the sheet density of the initial foamed sheet. Furthermore, the resulting article may, as a result of the post-expansion, have a density that is no more than 0.095 g/cm³, no more than 0.09 g/cm³, no more than 0.08 g/cm³, no more than 0.07 g/cm³, no more than 0.06 g/cm³, no more than 0.05 g/cm³, and/or no more than 0.04 g/cm³. Beneficially, the cellulose ester-based thermoformed article may achieve such post-expansion without a significant amount of blowing agent remaining within the thermoformed article (or in the preceding foamed sheet). In particular, it has been determined that most of the of the blowing agent used during extrusion to form the cellulose ester-based foamed sheet will diffuse and/or escape from the foamed sheet soon after extrusion. For instance, in some embodiments, the foamed article will have less than 1 wt. %, less than 0.5 wt. %, and/or less than 0.1 wt. % of the physical blowing agent within 24 hours, within 12 hours, within 6 hours, within 2 hours, within 1 hour, within 30 minutes, within 10 minutes, and/or or within 1 minute after the thermoforming.

### Abbreviations

BA is blowing agent; tPent is t-pentane; IsoPent is isopentane, nPent is n-pentane; CycloPent is cyclopentane; IsoBut is isobutane; Styr is styrene; PolyStyr is polystyrene; TA is triacetin;

For example, several sample trays were formed and tested for density change and for blowing agent content after thermoforming. The trays were formed from a cellulose ester foam sheet that was extruded using a tandem extruder system. The cellulose ester melt resin that was extruded comprised cellulose diacetate with a degree of substitution of 2.52, a melting point from 230-250° C., and a Tg of 189° C. The melt resin was plasticized with triacetin at either 15 wt. % or 20 wt. % loading. Talc was used as a nucleating agent, which along with a physical blowing agent, was mixed into the melt resin within a twin screw extruder of the tandem extruder system. The resulting melt resin was transferred to a single screw extruder, with which an annular die was used to extrude a cellulose ester foam sheet. The foam sheet was stretched, cut, and thermoformed to form a foam tray. A counterexample foamed tray comprising polystyrene was also formed in similar manner.

The densities of the sample trays were tested before and after thermoforming using an analytical balance where the samples were immersed in water and Archimedes principle was used to measure the volume. The method is described in DIN EN ISO 1183-1, ISO 2781. A minimum of three samples were measured and a weight of each sample was between 1-5 gm. The results of the density measurement for the samples are shown below in Table 4. Although the polystyrene counterexample tray was shown to have the highest post-expansion, the cellulose ester-based trays were able to achieve 60 to 80% of the polystyrene post-expansion.

TABLE 4

| | Decrease in density |
|---|---|
| Ex # | after thermoforming |
| 1 | 28% |
| 2 | 39% |
| PolyStyr | 48% |

In addition, residual blowing agents that remained in the sample trays after thermoforming were measured using liquid chromatography-mass spectrometry (LC/MS). The gases escaping during thermoforming were captured using head-space gas chromatography, by heating the samples to 200° C. For quantification of the volatiles, the samples were dissolved in solvent and components measured using LC/MS. The blowing agents used in all samples were hydrocarbons. As shown in Table 5, it was found that significantly lower hydrocarbon blowing agent dissolved in cellulose ester-based trays than with the polystyrene trays. Such a reduction in blowing agent is likely due to hydrocarbon gases having a solubility parameter similar to polystyrene and, thus, having better solubility in polystyrene than cellulose ester. As a result, foamed sheets formed from polystyrene would likely need to be staged and stored for an increased amount of time after extrusion (and before thermoforming) to allow for the blowing agent to be sufficiently diffused out of the sheets. In contrast, the cellulose ester based foamed sheets can be more quickly thermoformed as most of the blowing agent is immediately diffused out after extrusion of the foamed sheets. In addition, because the blowing agent is not retained by the cellulose ester-based foamed sheets and/or articles, there is a wider range of commercially relevant blowing agents that can be used to extrude cellulose ester-based foam sheets.

TABLE 5

| | | | Volatiles Remaining | | | | | |
|---|---|---|---|---|---|---|---|---|
| | | BA detected | IsoBut | tPent | IsoPent | nPent | CycloPent | Styr |
| Ex # | TA | (using GC) | (wt %) | (wt %) | (wt %) | (wt %) | (wt %) | (wt %) |
| 1 | 20% | tPent | | 0.0008 | | | | |
| 2 | 15% | Mixture | | | 0.0115 | 0.0573 | 0.0022 | |
| | | (IsoPent, | | | | | | |
| | | nPent) | | | | | | |
| PolyStyr | NA | IsoBut/Styr | 1.3355 | | | | | 0.0239 |

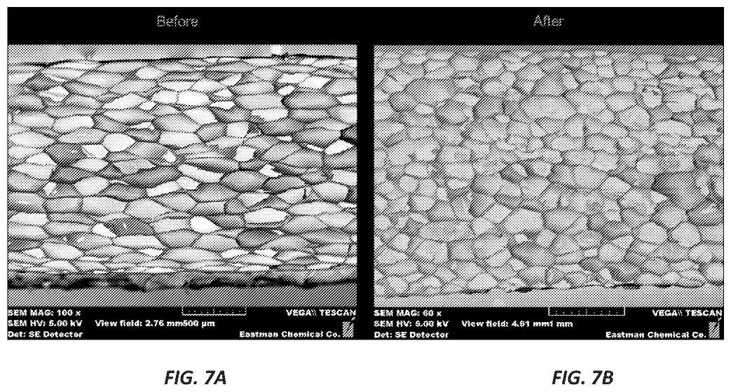

Some of such above-described benefits of cellulose ester-based foamed articles may be achieved via the change in cell shape that occurs after thermoforming. During extrusion of foam sheets using annular die, the sheets are pulled over the mandrel which stretches the sheets elongates the cells. As the foam sheets cool, cells are generally frozen in place in an elongated shape. When exposed to heat during thermoforming, the cells of the cellulose-ester based foamed articles are beneficially expanded to regain a more circular shape. FIG. 7A is a scanning electron microscope (SEM) image of a cross section of a cellulose ester-based foamed sheet prior to thermoforming. FIG. 7B is a SEM image of the cellulose ester-based foamed sheet after thermoforming. As shown, the cells of the cellulose ester-based foamed sheet are more round in shape after thermoforming, having a lower aspect ratio (i.e., width:height). Thus, in some embodiments, a foamed article comprising cellulose ester is provided, with the foamed article comprising a plurality of cells. Embodiments provide for at least 50% of the plurality of cells to have a cross-sectional aspect ratio from 1:2 to 2:1. In other embodiments, least 50% of the plurality of cells may have a cross-sectional aspect ratio from 1:1.8 to 1.8:1, from 1:1.6 to 1.6:1, from 1:1.4 to 1.4:1, and/or from 1:1.2 to 1.2:1.

In one embodiment or in combination with any of the embodiments mentioned herein, the foamed articles, e.g., trays may have a density less than 0.20 g/cm³, less than 0.18 g/cm³, less than 0.15 g/cm³, less than 0.12 g/cm³, less than less than 0.10 g/cm³, less than 0.08 g/cm³, less than less than 0.06 g/cm³, or less than less than 0.04 g/cm³, or from 0.04 to 0.8 g/cm³, 0.04 to 0.6 g/cm³, 0.04 to 0.5 g/cm³, 0.04 to 0.4 g/cm³, 0.04 to 0.3 g/cm³, 0.04 to 0.2 g/cm³, 0.04 to 0.15 g/cm³, 0.04 to 0.12 g/cm³, 0.04 to 0.10 g/cm³, 0.04 to 0.08 g/cm³, 0.04 to 0.06 g/cm³, 0.06 to 0.8 g/cm³, 0.06 to 0.6 g/cm³, 0.06 to 0.5 g/cm³, 0.06 to 0.4 g/cm³, 0.06 to 0.3 g/cm³, 0.06 to 0.2 g/cm³, 0.06 to 0.15 g/cm³, 0.06 to 0.12 g/cm³, 0.06 to 0.10 g/cm³, 0.06 to 0.08 g/cm³, 0.08 to 0.8 g/cm³, 0.08 to 0.6 g/cm³, 0.08 to 0.5 g/cm³, 0.08 to 0.4 g/cm³, 0.08 to 0.3 g/cm³, 0.08 to 0.2 g/cm³, 0.08 to 0.15 g/cm³, 0.08 to 0.12 g/cm³, 0.08 to 0.10 g/cm³, 0.1 to 0.8 g/cm³, 0.1 to 0.6 g/cm³, 0.1 to 0.5 g/cm³, 0.1 to 0.4 g/cm³, 0.1 to 0.3 g/cm³, 0.1 to 0.2 g/cm³, 0.1 to 0.15 g/cm³, 0.1 to 0.12 g/cm³, 0.2 to 0.8 g/cm³, 0.2 to 0.6 g/cm³, 0.2 to 0.5 g/cm³, 0.2 to 0.4 g/cm³, 0.2 to 0.3 g/cm³, 0.3 to 0.6 g/cm³, 0.3 to 0.5 g/cm³, 0.3 to 0.4 g/cm³, 0.4 to 0.6 g/cm³, 0.4 to 0.5 g/cm³, or 0.5 to 0.6 g/cm³.

In one embodiment or in combination with any of the embodiments mentioned herein, the average foam cell size is from 40 μm to 600 μm, or 50 μm to 600 μm, or 60 μm to 600 μm, or 70 μm to 600 μm, or 80 μm to 600 μm, or 90 μm to 600 μm, or 100 μm to 600 μm, or 150 μm to 600 μm, or 200 μm to 600 μm, or 250 μm to 600 μm, or 300 μm to 600 μm, or 400 μm to 600 μm, or 500 μm to 600 μm, or 40 μm to 550 μm, or 40 μm to 500 μm, or 40 μm to 450 μm, or 40 μm to 400 μm, or 40 μm to 350 μm, or 40 μm to 300 μm, or 40 μm to 250 μm, or 40 μm to 200 μm, or 40 μm to 150 μm, or 40 μm to 100 μm.

Furthermore, it should be understood that because the foamed articles, e.g., trays, are formed from the cellulose ester described herein, the foamed articles may include any of the components and/or additives, as well as any resulting properties, of the cellulose ester based materials described herein.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

To be considered “compostable,” a material should meet one or more of the following criteria: (1) the material is biodegradable; (2) the material is disintegrable; (3) the material does not contain more than a maximum amount of heavy metals; and/or (4) the material is not be ecotoxic.

As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

To be considered “home compostable,” under home composting conditions according to the French norm NF T 51-800, a material must exhibit a disintegration of at least 90 percent in total (e.g., as compared to the initial sample) within 12 weeks, as measured according to ISO 16929 (2013) under an ambient temperature (i.e., 28° C.±2° C.).

To be considered “industrial compostable,” under industrial composting conditions according to ASTM D6400, a material must exhibit a disintegration of at least 90 percent in total (e.g., as compared to the initial sample) within 26 weeks, as measured according to ISO 16929 (2013) under an elevated temperature (i.e., 58° C.±2° C.).

In one embodiment or in combination with any of the embodiments mentioned herein, the biodegradable cellulose ester foam or article (e.g., a tray) is industrial compostable and/or home compostable. Specifically, the foamed material from which the articles described herein are made, may be industrial compostable according to ASTM D6400 and exhibit disintegration of at least ninety percent within twelve weeks, as measured according to ISO 16929 (2013) under an elevated temperature of 58° C.±2° C. In addition, or in the alternative, the foamed material from which the articles described herein are made, may be home compostable according to French Standard NF T 51-800 and exhibit disintegration of at least ninety percent within twenty-six weeks, as measured according to ISO 16929 (2013) under an ambient temperature of 28° C.±2° C.

In some specific embodiments, the foamed material may be industrial compostable when formed into a foamed article having a thickness of no more (or equal to) 200 mils and a density of no more (or equal to) 0.2 g/cm³. Alternatively, or in addition, the foamed material may be industrial compostable when formed into a foamed article having a thickness of no more (or equal to) 400 mils and a density of no more (or equal to) 0.1 g/cm³. Alternatively, or in addition, the foamed material may be industrial compostable when formed into a foamed article having a thickness of no more (or equal to) 800 mils and a density of no more (or equal to) 0.05 g/cm³. Alternatively, or in addition, the foamed material may be home compostable when formed into a foamed article having a thickness of no more (or equal to) 100 mils at a density of no more (or equal to) 0.2 g/cm³. Alternatively, or in addition, the foamed material may be home compostable when formed into a foamed article having a thickness of no more (or equal to) 200 mils at a density of no more (or equal to) 0.1 g/cm³. Alternatively, or in addition, the foamed material may be home compostable when formed into a foamed article having a thickness of no more (or equal to) 400 mils at a density of no more (or equal to) 0.05 g/cm³.

The compositions used to prepare the biodegradable cellulose acetate foams can comprise other additives such as fillers, stabilizers, odor modifiers, waxes, compatibilizers, biodegradation promoters, dyes, pigments, colorants, lubricants, anti-oxidants, viscosity modifiers, antifungal agents, heat stabilizers, antibacterial agents, softening agents, mold release agents, UV absorbers, hydrophobic additives, and combinations thereof. Each additional additive may be present in the cellulose ester-based material in an amount less than 10 wt. %, less than 5 wt. % less than 4 wt. %, less than 3 wt. %, less than 2 wt. %, or less than 1.0 wt. %. It should be noted that the same type of compounds or materials can be identified for or included in multiple categories of components in the cellulose acetate compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In one embodiment or in combination with any other embodiment mentioned herein, the foam, composition or foamable composition further comprises a photodegradation catalyst. In one class of this embodiment, the photodegradation catalyst is a titanium dioxide, or an iron oxide. In one subclass of this class, the photodegradation catalyst is a titanium dioxide. In one subclass of this class, the photodegradation catalyst is an iron oxide.

In one embodiment or in combination with any other embodiment mentioned herein, the foam, composition, or foamable composition further comprises a pigment. In one class of this embodiment, the pigment is a titanium dioxide, a carbon black, or an iron oxide. In one subclass of this class, the pigment is a titanium dioxide. In one subclass of this class, the pigment is a carbon black. In one subclass of this class, the pigment is an iron oxide. In one subclass of this class, the pigment is a biodegradable particulate natural filler.

### Abbreviations

Wt is weight, wt % is weight percent, IR is infrared; Ex is example(s),

### Film and Foam Sheet Production and Thermoforming

One foot wide films were extruded on a 1.5″ Killion Extruder at the desired thickness below. The extrusion conditions were set based on the polymer with PETG, Eastman cellulose acetate FT1150 and Eastman cellulose acetate FT1200 being extruded between 22° and 240° C. through a coat hanger type die at the desired thickness as controlled by the take-off assembly.

Foam sheet samples were made on a tandem foam line manufactured by Krauss Maffei. The extrusion lines consists of a ZE30 twin screw extruder as the primary extruder coupled to a KE60 single screw extruder as the secondary cooling extruder. Formulation additives are dosed in to the KE30 twin screw feeder using loss and weight feeders. Physical blowing agents are injected into the barrel of the primary extruder about ½ to ⅔ down the barrel of the primary extruder. Material is extruded out a 50 mm annual die and conveyed over a sizing mandrel. The annular film is then slit and turned into a flat film in the tension/take up station part of the roll.

Material composition is a cellulose acetate resin (e.g., Eastman cellulose acetate CA-398-30 or FE700) having 20 weight % triacetin, 1% epoxidized soybean oil, and 0.15% doverphos S9228T and other minor stabilizers/odor mask. The material is injected with 2.6 wt % n-pentane as the blowing agent. Additional additives to the process include 1.5 wt % ABT 1000 talc and a 1% of a chemical blowing agent (foamazol 73S). The materials were extruded between 20° and 220° C. in the primary extruder and 170-190° C. in the secondary extruder. The output rate of the line was 40 kgs/hr. The foam produced for this test had a density of 0.95 g/cc and an average cell size of 342 microns.

Film were placed on the top side of the foam and clamped in the frame of the Hydrotrim Lab thermoformer. The unit has top and bottom heating platens in the oven, a timer to set the hold time in the ovens, vacuum for drawing the material in the molds and plug assist for use with complicated parts. The materials evaluated for this study were made using vacuum only and the top and bottom platens were heated to 260° C. The sheet temperature was measured by an infrared thermometer to between 19° and 205° C. when the parts were heated for 34 seconds.

The moisture absorption test was previously described.

Solid skin layers can be made by any process including during foam process by controlling the evaporation rate of the blowing agent to solidify thicker skins, by coextrusion to put a layer on the foam as it was being manufactured. This layer can be on one side to produce an A/B (film/foam) structure or ABA (film/foam/film) structure etc. In addition, the foam can be laminated in a secondary roll to roll process to produce the same structures or during the thermoforming process as well. The foam parts can be made with vacuum only or preferably with plug assist or matched mold sets to insure best part distribution etc. The film layers can be as thin as 0.0001 to 0.05 inches (0.0025 to 1.27 mm)

TABLE 6
Water uptake of laminated foam.

| | | Film | Wt % | Wt % | Wt % | Wt % | Wt % | Wt % | % reduction |
|---|---|---|---|---|---|---|---|---|---|
| Ex | Film | Thickness | gain | gain | gain | gain | gain | gain | vs. control, |
| # | type | (mils) | (1 h) | (2 h) | (4 h) | (8 h) | (18 h) | (24 h) | 24 h |
| 1 | None | None | 1.99 | 3.00 | 5.32 | 5.47 | 9.17 | 11.31 | n/a |
| 2 | PETG | 1 | 1.51 | 2.46 | 2.3 | 2.54 | 2.84 | 2.85 | −74.8 |
| 3 | PETG | 3 | 0.00 | 0.18 | 0.47 | 0.83 | 1.73 | 1.99 | −82.4 |
| 4 | PETG | 5 | 0.48 | 0.48 | 0.53 | 0.52 | 0.59 | 0.64 | −94.3 |
| 5 | PBSFD92 | 1 | 1.10 | 1.10 | 1.66 | 1.42 | 1.92 | 2.21 | −80.5 |
| 6 | PBSFD92 | 3 | 0.38 | 0.95 | 2.66 | 2.58 | 2.87 | 2.89 | −74.4 |
| 7 | PBSFD92 | 5 | 0.16 | 0.16 | 0.16 | 0.23 | 0.33 | 0.47 | −95.8 |
| 8 | FT1150 | 1 | 1.62 | 2.61 | 1.96 | 2.58 | 2.87 | 3.40 | −69.9 |
| 9 | FT1150 | 3 | 2.2 | 2.75 | 3.58 | 2.97 | 3.57 | 3.84 | −66.0 |
| 10 | FT1150 | 5 | 0.68 | 1.55 | 1.38 | 1.72 | 2.02 | 2.06 | −81.8 |
| 11 | FT1200 | 1 | 1.22 | 1.21 | 1.57 | 2.04 | 2.46 | 2.95 | −73.9 |
| 12 | FT1200 | 3 | 1.33 | 1.33 | 1.6 | 1.96 | 2.86 | 3.46 | −69.4 |
| 13 | FT1200 | 5 | 0.85 | 1.18 | 1.52 | 1.47 | 1.68 | 1.69 | −85.1 |

Table 7 shows the disintegration of the foams according to ISO 20200 and ISO 16929 at ambient and elevated temperatures.

TABLE 7
Foam composting disintegration at
elevated and ambient temperatures.

| | | | Disintegration | |
|---|---|---|---|---|
| | Foam | Density | | % |
| Ex # | Thickness | (g/cm³) | Test | disintegration |
| 14 | 36 mil | 0.7 | ISO 20200 | 100% |
| | | | (Elevated T⁰) | |
| 15 | 32 mil | 0.6 | ISO 20200 | 98.9% |
| | | | (Ambient T⁰) | |
| 16 | 200 mil | 0.2 | ISO 20200 | 100% |
| | | | (Elevated T⁰) | |
| 17 | 98 mil | 0.12 | ISO 16929 | 100% |
| | | | (Ambient T⁰) | |
| 18 | 164 mil | 0.07 | ISO 16929 | 100% |
| | | | (Ambient T⁰) | |
| 19 | 212 mil | 0.01 | ISO 16929 | 100% |
| | | | (Elevated T⁰) | |
| 20 | 259 mil | 0.01 | ISO 16929 | 100% |
| | | | (Elevated T⁰) | |
| 21 | 212 mil | 0.01 | ISO 16929 | 94% |
| | | | (Ambient T⁰) | |
| 22 | 259 mil | 0.01 | ISO 16929 | 96% |
| | | | (Ambient T⁰) | |

Foam sheet samples were made on a tandem foam line manufactured by Krauss Maffei. The extrusion lines consists of a ZE30 twin screw extruder as the primary extruder coupled to a KE60 single screw extruder as the secondary cooling extruder. Formulation additives are dosed in to the KE30 twin screw feeder using loss and weight feeders. Physical blowing agents are injected into the barrel of the primary extruder about ½ to ⅔ down the barrel of the primary extruder. Material is extruded out a 50 mm annual die and conveyed over a sizing mandrel. The annular film is then slit and turned into a flat film in the tension/take up station part of the roll.

Material 1 composition is a cellulose acetate resin (Eastman cellulose acetate CA-398-30 or Eastman cellulose acetate FE700) having 20 wt % triacetin, 1% epoxidized soybean oil, and 0.15 wt % doverphos S9228T and other minor stabilizers/odor mask. The material is injected with 2.6 wt % n-pentane as the blowing agent. Additional additives to the process include 1.5 wt % ABT 1000 talc and a 1 wt % of a chemical blowing agent (foamazol 73S) The materials were extruded between 20° and 220° C. in the primary extruder and 170-190° C. in the secondary extruder. The output rate of the line was 40 kgs/hr.

Material 2 composition is a cellulose acetate resin (Eastman cellulose acetate CA-398-30 or Eastman cellulose acetate FE700) having 15 wt % triacetin, 1 wt % epoxidized soybean oil, and 0.15 wt % Doverphos S9228T and other minor stabilizers/odor mask. The material is injected with 2.5 wt % n-pentane as the blowing agent. Additional additives to the process include 1.0 wt % ABT 1000 talc and a 1 wt % of a chemical blowing agent (Foamazol 73S) The materials were extruded between 20° and 220° C. in the primary extruder and 180-200° C. in the secondary extruder. The output rate of the line was 40 kgs/hr.

Material 3 composition is a cellulose acetate resin (Eastman cellulose acetate CA-398-30 or Eastman cellulose acetate FE700) having 15 wt % triacetin, 1 wt % epoxidized soybean oil, and 0.15 wt % Doverphos S9228T and other minor stabilizers/odor mask. The material is injected with 2.3 wt % n-pentane as the blowing agent. Additional additives to the process include 1.0 wt % ABT 1000 talc and a 1 wt % of a chemical blowing agent (Foamazol 73S) The materials were extruded between 20° and 220° C. in the primary extruder and 170-190° C. in the secondary extruder. The output rate of the line was 40 kgs/hr.

Materials were thermoformed on a Hydrotrim Lab thermoformer. The unit has top and bottom heating platens in the oven, a timer to set the hold time in the ovens, vacuum for drawing the material in the molds and plug assist for use with complicated parts. The materials evaluated for this study were made using vacuum only and the top and bottom platens were heated to 260° C. The sheet temperature was measured by an infrared thermometer to between 157 and 197° C.

TABLE 8

| | | Sheet | | | | |
|---|---|---|---|---|---|---|
| | | IR | | Sheet | Article | Density |
| | | Temp | Triacetin | Density | Density | decrease |
| Ex # | Material | (° C.) | (wt %) | (g/cm³) | (g/cm³) | (%) |
| 23 | 1 | 191 | 20 | 0.0948 | 0.072 | 24% |
| 24 | 2 | 191 | 15 | 0.095 | 0.066 | 30% |

TABLE 9

| | | | Thermoforming | Sheet | Article | Density |
|---|---|---|---|---|---|---|
| Ex | | Triacetin | sheet temper- | Density | density | decrease |
| # | Material | (wt %) | ature ° C. | (g/cc) | (g/cc) | (%) |
| 25 | 3 | 20 | 157.22 | 0.105 | 0.089 | 15.2 |
| 26 | 3 | 20 | 170.56 | 0.105 | 0.090 | 14.3 |
| 27 | 3 | 20 | 180.56 | 0.105 | 0.089 | 15.2 |
| 28 | 3 | 20 | 192.2 | 0.105 | 0.087 | 17.1 |
| 29 | 3 | 20 | 197.2 | 0.105 | 0.084 | 20.0 |
| 30 | 2 | 15 | 165.0 | 0.095 | 0.074 | 22.1 |
| 31 | 2 | 15 | 184.4 | 0.095 | 0.075 | 21.1 |
| 32 | 2 | 15 | 196.7 | 0.095 | 0.071 | 25.3 |

Material 4 composition is a cellulose acetate resin (Eastman cellulose acetate CA-398-30 or Eastman cellulose acetate FE700) having 20 wt % triacetin, 1 wt % epoxidized soybean oil, and 0.15 wt % Doverphos S9228T and 1 wt % zinc stearate The material is injected with 2.6 wt % n-pentane as the blowing agent. Additional additives to the process include 1 wt % ABT 1000 talc and a 1 wt % of a chemical blowing agent (Foamazol 73S). The materials were extruded between 20° and 220° C. in the primary extruder and 170-190° C. in the secondary extruder. The output rate of the line was 40 kgs/hr.

Materials (e.g., Materials 1, 2, and 4) were thermoformed on a Hydrotrim Lab thermoformer. The unit has top and bottom heating platens in the oven, a timer to set the hold time in the ovens, vacuum for drawing the material in the molds and plug assist for use with complicated parts. The materials evaluated for this study were made using vacuum only and the top and bottom platens were heated to 260° C. The sheet temperature was measured by an infrared thermometer to between 18° and 197° C.

TABLE 10

| | | | Sheet | Article | Density |
|---|---|---|---|---|---|
| Ex | | Triacetin | Density | density | decrease |
| # | Material | (wt %) | (g/cm³) | (g/cm³) | (%) |
| 33 | 1 | 20 | 0.095 | 0.072 | 24% |
| 34 | 2 | 15 | 0.092 | 0.065 | 29% |
| 35 | 4 | 20 | 0.128 | 0.098 | 24% |

TABLE 11

| | | | | Post | |
|---|---|---|---|---|---|
| | | | Initial | forming | Thickness |
| Ex | | Triacetin | Thickness | expansion | Increase |
| # | Material | (wt %) | (mm) | (mm) | (%) |
| 36 | 1 | 20 | 4.11 | 5.12 | 24.4 |
| 37 | 2 | 15 | 4.35 | 5.26 | 20.9 |
| 38 | 4 | 20 | 3.65 | 4.61 | 26.5 |

### Method Summary

A sheet of foamed cellulose acetate (Eastman cellulose acetate CA-398-30 or Eastman cellulose acetate FE700) was conditioned for seven days in a desiccator where the desiccant replaced with a small pan containing pentane to maintain a saturated atmosphere. Triplicate 4 cm×5 cm sub-samples were cut from the larger sheet sample. These sub-samples were placed in separate resealable 5×7 cm polyethylene bags and quickly returned to the desiccator. The bags were kept open to facilitate re-establishment of pentane saturation. After three hours, the samples were tested individually by removing the bag containing the foam from the desiccator, quickly sealing the bag and recording the weight. The foam piece was then removed from its bag, placed in a small oven at 186±1.0° C. for 45 seconds. Once the heating period was over, the sample was removed from the oven, sealed quickly in its original bag and reweighed.

### Experimental Apparatus

The oven used was a Pierce Reacti-Therm III Heating/Stirring Module utilizing an aluminum heat block with a large hole approximately 4.5 cm in diameter and 5 cm in depth and open on top. This hole was used as the heating chamber. An additional aluminum heat block was placed on each side of the heating chamber for additional thermal mass, and a stainless-steel slab approximately 3 inches by 6 inches by %-inches thick was placed on top and used to seal the mini-chamber while heating the sample. Temperature in the heating chamber was monitored with a Amprobe TMD-56 digital thermometer and thermocouple placed in a thermal well drilled into the heat block. Samples were weighed on a Mettler Toledo XPE56 6-place microbalance and timing was accomplished with a digital lab timer. The entire oven apparatus was placed in a fume hood during the course of the experiment.

The above method was used to simulate thermoforming to get an accurate measurement of Cellulose Acetate maximum blowing agent retention during thermoforming conditions. The ovens in thermoforming are typically at 250 to 350 C. The ovens can be set constant temperature or gradually increasing as the sheet transverses the oven. The sheet temperature is 180 to 200° C. prior to forming to ensure the sheet stretches well into the mold. The blowing agent in making the foam is typically around 2.3 to 3.5% hydrocarbon during extrusion and usually half or more is lost during the extrusion process as the foam cools.

TABLE 12

| | Foam weight | | % pentane | |
|---|---|---|---|---|
| | without | Wt % pentane | loss upon | % pentane |
| Ex # | Pentane | at saturation | heating | remaining |
| 39 | 0.8507 | 2.59% | 84% | 0.41% |
| 40 | 0.8094 | 2.11% | 81.7% | 0.39% |
| 41 | 0.8138 | 2.37% | 80.2% | 0.47% |

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A foamed tray comprising a cellulose ester and a hydrophobic cap layer formed on an exterior surface of the foamed tray and,
wherein the tray is configured to experience a weight gain of less than 10% when submitted to a One-Hour Water Absorption Test, as described in the specification.

2. The foamed tray of claim 1, wherein the hydrophobic cap layer is formed on an exterior surface of the foamed tray.

3. The foamed tray of claim 1, wherein the hydrophobic cap layer is formed an upper surface of the tray.

4. The foamed tray of claim 1, wherein the hydrophobic cap layer is formed on the surface of the tray that forms the bowl or receiving area that is configured to support a food item.

5. The foamed tray of claim 1, wherein the foamed tray is formed from a foamed sheet comprising a hydrophobic cap layer formed on an exterior surface of the foamed sheet from a coextrusion process, a laminating process, or a coating process.

6. The foamed tray of claim 1, wherein the foamed tray is configured to support a food item.

7. The foam tray of claim 1, wherein the food item is one or more of the following: an animal or plant protein, a vegetable, or a fruit.

8. The foamed tray of claim 1, wherein the foamed tray includes an absorbent pad.

9. The foamed tray of claim 1, wherein the foamed tray is configured to be wrapped with shrink film or overwrap film.

10. The foamed tray of claim 1, wherein the foamed tray has a width in the range of 2-14 inches.

11. The foamed tray of claim 1, wherein the foamed tray has a length that is 1.2-4 times the width of the tray.

12. The foamed tray of claim 1, wherein the foamed tray has a depth from 0.3 to 4 inches.

13. The foamed tray of claim 1, wherein the thickness of the foamed tray is from 1 to 10 mm.

14. The foamed tray of claim 1, wherein when the foamed tray is filled with water and allowed to equilibrate at room temperature for 18 hours, the foamed tray has a weight gain of less than 15% according to the Water Absorption Test described in the specification.

15. The foamed tray of claim 1, wherein the foamed tray is industrial compostable according to ASTM D6400 thereby exhibiting disintegration of at least 70 percent, or at least 80 percent, or at least 90 percent within twelve weeks, as measured according to ISO 16929 (2013) under an elevated temperature of 58° C.±2° C., and
wherein the foamed tray is home compostable according to French Standard NF T 51-800 thereby exhibiting disintegration of at least 70 percent within twenty-six weeks, as measured according to ISO 16929 (2013) under an ambient temperature of 28° C.±2° C.

16. A method of forming a foamed article, the method comprising:
(a) producing a foamed sheet from a composition comprising cellulose ester and having a sheet density; and
(b) thermoforming the foamed sheet, thereby forming the foamed article having an article density, wherein the article density is at least 20% less than the sheet density.

17. The method of claim 16, wherein the article density is at least 25% than the sheet density.

18. The method of claim 16, wherein the article density is no more than 0.095 g/cm³.

19. The method of claim 16, wherein the foamed article is a foamed tray configured to support a food item.

20. The method of claim 16, wherein the composition comprises a cellulose ester, a plasticizer, a nucleating agent, and a physical blowing agent.

21. The method of claim 20, wherein the composition comprises 2-40 wt % plasticizer.

22. The method of claim 21, wherein the plasticizer comprises triacetin.

23. The method of claim 16, wherein the foamed article comprises one or more additional additives.

24. The method of claim 23, wherein the additional additives are present in an amount less than 10 wt. %.

25. The method of claim 16, wherein the foamed article has less than 1% of the physical blowing agent twenty-four hours after the thermoforming.

26. The method of claim 25, wherein the foamed article comprises less than 0.5% of the physical blowing agent 12 hours after the thermoforming.
